(19) United States
(12) Patent Application Publication
(10) Pub. No.: US 2011/0103211 A1
(43) Pub. Date: May 5, 2011

(54) OPTICAL RECORDING MEDIUM, METHOD OF MANUFACTURING OPTICAL RECORDING MEDIUM, RECORDING METHOD AND REPRODUCING METHOD

(75) Inventors: Goro Fujita, Kanagawa (JP); Kimihiro Saito, Kanagawa (JP)

(73) Assignee: Sony Corporation, Tokyo (JP)

(21) Appl. No.: 12/873,421

(22) Filed: Sep. 1, 2010

(30) Foreign Application Priority Data
Sep. 8, 2009 (JP) 2009-206756

(51) Int. Cl. G11B 7/24; G11B 7/00; B32B 37/00

(52) U.S. Cl. 369/100; 369/286; 156/60; G9B/7.159; G9B/7

(57) ABSTRACT

An optical recording medium includes recording layers and intermediate layers. The recording layers include a diffraction grating that has a predetermined grating pitch and is obtained by alternately laminating first layers and second layers being transparent and having slightly different refractive indexes. The intermediate layers are transparent and have a larger thickness than that of the recording layers. In the optical recording medium, the recording layers and the intermediate layers are alternately laminated.

### BACKGROUND OF THE INVENTION

1. Field of the Invention

The present invention relates to an optical recording medium on/from which a signal is recorded/reproduced by emission of light, and particularly relates to an optical recording medium in which recording layers and intermediate layers are alternately laminated and a method of manufacturing the optical recording medium.

Further, the present invention relates to a recording method and a reproducing method for the optical recording medium.

2. Description of the Related Art

As optical recording media on/from which signals are recorded/reproduced by emission of light, for example, so-called optical discs such as CD (Compact Disc), DVD (Digital Versatile Disc) and BD (Blu-ray Disc: registered trade name) become widely used.

The applicant proposes so-called bulk recording type optical recording media as described in Japanese Patent Application Laid-open Nos. 2008-135144 (Patent Document 1) and 2008-176902 (Patent Document 2) as optical recording media that are responsible for the next generation of the optical recording media such as CD, DVD and BD that are widely used at the present.

The bulk recording is a technique that emits a laser beam to an optical recording medium having at least a cover layer 101 and a bulk layer (recording layer) 102 as shown in FIG. 12 with a focus position being successively changed and performs multi-layer recording in the bulk layer 102 so as to achieve a large recording capacity.

Patent Document 1 discloses the recording technique that is referred to as a so-called microhologram system relating to such bulk recording.

The microhologram system is roughly divided into a positive type microhologram system and a negative type microhologram system as shown in FIG. 13.

In the microhologram system, a so-called hologram recording material is used as a recording material of the bulk layer 102. A photopolymerized photopolymer or the like is widely known as the hologram recording material.

In the positive type microhologram system, opposed two beams of light (beam of light A and beam of light B) are condensed onto one position as shown in FIG. 13A so that fine interference fringes (hologram) are formed. These interference fringes are used as recording marks.

In the negative type microhologram system shown in FIG. 13B that is the opposite system to the positive type microhologram system, interference fringes formed in advance are eliminated by emission of a laser beam, and the deleted portions are used as recording marks.

The positive and negative type microhologram systems are recording systems that are very advantageous to the multi-layer recording. These microhologram systems use a diffraction grating as a mark (in the case of the negative type, a mark unformed portion is a diffraction grating). However, when light is emitted so as to be condensed on the diffraction grating, the diffraction grating functions as a reflector due to its refractive index difference. In microhologram type optical recording media in which such a diffraction grating is formed in the bulk layer 102 as the recording layer, light transmittance is higher on a portion other than an emitted light condensed portion than optical recording media having recording layers whose marks are formed by a change in a refractive index or sublimation of a film that are used in related optical disc systems. As a result, even when the multi-layer recording is performed, light easily reaches back portions of the recording layers (bulk layers). That is to say, due to this point, the microhologram systems are advantageous to the multi-layer recording.

However, the feasibility of the positive type microhologram system of the positive and negative type microhologram systems is very low.

Specifically, in the positive type microhologram system, the opposed beam of light A and beam of light B are condensed on one position as shown in FIG. 13A so that the recording mark (hologram) is formed. However, in order to realize this, very accurate control is requested for the control of the position where both the beams of light are emitted. Since the very high accuracy of the position control is requested, the positive type microhologram system has a great technical difficulty in its realization. Even if this system is realized, an increase in the manufacturing cost of apparatuses is not avoided, and thus this is not a realistic method.

On the contrary, in the negative type microhologram system, two different beams of light do not have to be condensed on one position, and thus the technical difficulty in the control accuracy of laser beams on the emitting position is in no danger of being caused.

The negative type microhologram system is described more specifically with reference to FIGS. 14A and 14B.

In the negative type microhologram system, before a recording operation is performed, an initializing process for forming interference fringes on the bulk layer 102 is executed in advance as shown in FIG. 14A. More specifically, beams of light C and D obtained by parallel light are emitted in an opposed manner as shown in the drawing, and their interference fringes are formed on the entire bulk layer 102.

After the interference fringes are formed at the initializing process in advance, information is recorded by forming a deletion mark as shown in FIG. 14B. More specifically, a laser beam is emitted according to the recording information with being focused on any layer position so that the information is recorded by the deletion mark.

According to the principle of the positive type microhologram described with reference to FIG. 13A, two beams of light are condensed on one position as the initializing process. However, when the initializing process is executed by condensing two beams of light, the initializing process should be executed according to a set number of layers, and thus this is not a realistic method. Therefore, the initializing process is executed by using parallel light as described above, with the result that the time for the initializing process is greatly shortened.

In the negative type microhologram systems, two laser beams do not have to be condensed and emitted to one position unlike the positive type microhologram system, and thus the problem from the viewpoint of the position control accuracy is solved.

### SUMMARY OF THE INVENTION

However, in the related negative type microhologram system with reference to FIGS. 14A and 14B, the initializing process for an optical recording medium is typically executed before recording. That is to say, a delay occurs due to the initializing process until an actual recording operation according to recording data is started.

In the past negative type microhologram systems, parallel light is used for shortening the initializing process as described above, but when the initializing process is executed by the parallel light in such a manner, a very high power may be necessary as initializing light.

It is also considered that the initialization with low power is enabled by heightening recording sensitivity of the bulk layer 102. In this case, however, it is very difficult to form a fine mark.

Due to these points, the related negative type microhologram systems are hardly realized at the present.

In view of the forgoing, it is desirable to eliminate the initializing process necessary in the related negative type microhologram systems, and solve the problems caused by the above initializing process, and thus further heighten the feasibility of negative type microhologram systems.

According to an embodiment of the present invention, there is provided an optical recording medium having the following structure.

That is to say, the optical recording medium according to an embodiment of the present invention includes recording layers including a diffraction grating having a predetermined grating pitch, the diffraction grating being obtained by alternately laminating first layers and second layers being transparent and having slightly different refractive indexes, and intermediate layers being transparent and having a larger thickness than that of the recording layers, the recording layers and the intermediate layers being alternately laminated.

According to another embodiment of the present invention, there is provided a method of manufacturing an optical recording medium as follows.

That is to say, the manufacturing method according to the embodiment of the present invention is a method of manufacturing an optical recording medium in which recording layers and intermediate layers are alternately laminated, the method including: generating the recording layers including a diffraction grating, the diffraction grating being provided with a predetermined grating pitch by alternately laminating a first material and a second material that are transparent and have slightly different refractive indexes, into predetermined thicknesses at a several number of times; and generating the intermediate layers that are transparent and have a thickness larger than that of the recording layers.

According to an embodiment of the present invention, there is provided a recording method as follows.

That is to say, the recording method of recording a deletion mark on an optical recording medium according to recording information includes emitting a laser beam according to the recording information with a focus position of the laser beam matching with a recording layer of the optical recording medium as a target for recording, and planarizing a refractive index distribution on the recording layer as the target for the recording, the optical recording medium being configured by alternately laminating the recording layers and intermediate layers, the recording layers including a diffraction grating provided with a predetermined grating pitch by alternately laminating first layers and second layers that are transparent and have refractive indexes being slightly different from each other, the intermediate layers being transparent and having a larger thickness than that of the recording layers.

According to another embodiment of the present invention, there is provided a reproducing method as follows.

That is to say, the reproducing method for an optical recording medium includes: emitting a laser beam to the optical recording medium where a deletion mark corresponding to recording information is formed on recording layers of the optical recording medium with the laser beam being focused on the recording layer as a target for reproduction, the optical recording medium being configured by alternately laminating the recording layers and intermediate layers, the recording layers including a diffraction grating provided with a predetermined grating pitch by alternately laminating first layers and second layers that are transparent and have refractive indexes being slightly different from each other, the intermediate layers being transparent and having a larger thickness than that of the recording layers; detecting reflected light of the laser beam emitted at the emitting a laser beam; and reproducing the information recorded on the recording layer as the target for reproduction based on a detected result of the reflected light at the detecting reflected light.

The optical recording medium according to the embodiment of the present invention is provided with the recording layers including the diffraction grating formed by alternately laminating the first and second layers that are transparent and have refractive indexes slightly different from each other in advance. As a result, the initializing process for forming the recording layers that is executed in related negative type microhologram systems can be omitted.

According to the present invention, the initializing process for forming the recording layers (diffraction grating) used in the related negative type microhologram systems can be eliminated, and thus the time until the recording is started is greatly shortened.

Further, since the initializing process is eliminated, problems about a power of initializing light and a recording sensitivity of a bulk layer in the related negative type microhologram systems can be solved.

According to the present invention, when the negative type microhologram system is adopted, the problems in the related methods can be solved, thereby further heightening the feasibility of a multi-layer recording medium (large-capacity recording medium) using the negative type microhologram system.

Further, with the recording method and the reproducing method according to the embodiments of the present invention, recording and reproducing on and from the optical recording medium according to the embodiment of the present invention can be performed.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a cross-sectional structural diagram illustrating an optical recording medium according to an embodiment;

FIG. 2 is a diagram illustrating a cross-sectional structure of a recording layer formed on the optical recording medium according to the embodiment;

FIGS. 3A and 3B are diagrams for describing a microhologram (recording mark) to be recorded in a positive type microhologram system;

FIGS. 4A and 4B are diagrams for describing a diffraction efficiency of the microhologram recording mark;

FIGS. 5A and 5B are diagrams for describing a deletion mark;

FIGS. 6A to 6F are diagrams illustrating a comparison between the deletion mark and its reproduced signal when recording is performed by using laser beams with different light intensities;

FIGS. 7A to 7D are diagrams for describing a first method of manufacturing the optical recording medium according to the embodiment;

FIGS. 8A and 8B are diagrams illustrating one example of the method of manufacturing the recording layer;

FIGS. 9A to 9E are diagrams for describing a second method of manufacturing the optical recording medium according to the embodiment;

FIG. 10 is a diagram for describing a servo control method according to the embodiment;

FIG. 11 is a diagram illustrating an internal structure of a recording/reproducing apparatus according to the embodiment;

FIG. 12 is a diagram for describing a bulk recording system;

FIGS. 13A and 13B are diagrams for describing a microhologram system; and

FIGS. 14A and 14B are diagrams for describing a negative type microhologram system.

### DESCRIPTION OF PREFERRED EMBODIMENTS

A most preferred embodiment (hereinafter, referred to as embodiment) of the present invention will be described below.

The description proceeds in the following order.

### <1. Optical Recording Medium According to Embodiment>

[1-1. Structure of Optical Recording Medium]

[1-2. Deletion Mark and Reproduced Signal]

### <2. Method of Manufacturing Optical Recording Medium>

### <3. Effect of Optical Recording Medium According to Embodiment>

### <4. Servo Control>

### <5. Structure of Recording/Reproducing Apparatus>

### <6. Modified Example>

### 1. Optical Recording Medium according to Embodiment

### 1-1. Structure of Optical Recording Medium

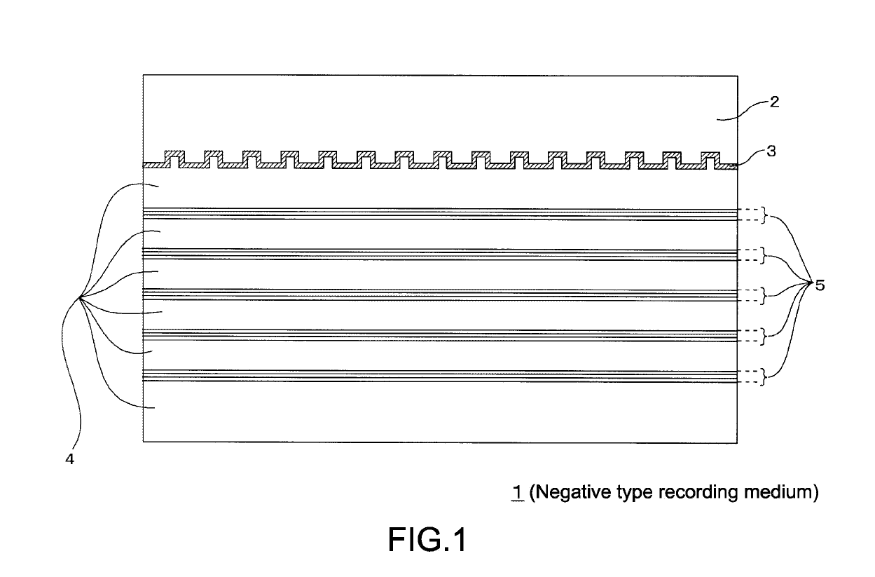

FIG. 1 is a cross-sectional structural diagram illustrating a negative type recording medium 1 as an optical recording medium according to one embodiment of the present invention.

At first, it is assumed that the negative type recording medium 1 according to this embodiment is a disc-shaped recording medium, and a laser beam is emitted to the rotating negative type recording medium 1 so that a mark (information) is recorded thereon. Further, the recording information is reproduced by emitting a laser beam to the rotating negative type recording medium 1.

As shown in FIG. 1, a cover layer 2 and a selective reflection film 3 are formed on the recording medium 1 according to this embodiment in this order from an upper layer side. Intermediate layers 4 and recording layers 5 are alternately and repeatedly laminated below the selective reflection film 3.

“The upper layer side” in this specification means an upper layer side when a surface where the laser beam from a recording/reproducing apparatus side, which will be described later, is incident is an upper surface.

The cover layer 2 is made of a resin such as polycarbonate or acrylic, and its lower surface side is provided with a convexo-concave cross-sectional shape due to forming of a race for guiding a recording/reproducing position as shown in FIG. 1.

As the race, a continuous groove or a pit array is formed. When the race is the groove, for example, the groove is formed so as to be periodically meandering, and thus position information (radius position information, rotation angle information and the like) can be recorded based on periodic information about the meandering.

The cover layer 2 is formed, for example, by injection molding using a stamper formed with such a race (convexo-concave shape).

The selective reflection film 3 is deposited on the lower surface side of the cover layer 2 formed with the race.

In a bulk recording system, besides recording light (first laser beam) for recording a mark on a bulk layer as the recording layer, servo light (second laser beam) for obtaining error signals of tracking and focus is emitted based on the above race.

At this time, if the servo light reaches the recording layer, the mark recording is in danger of being adversely affected. For this reason, a reflection film that selectively reflects the servo light and transmits the recording light is demanded.

In related art, laser beams having different wavelengths are used as the recording light and the servo light in the bulk recording system, and accordingly a selective reflection film having a wavelength selectivity for reflecting light with the same wavelength band as that of servo light and transmitting light with the other wavelengths is used as the selective reflection film 3.

In the negative type recording medium 1 according to this embodiment, an alternate layer including the intermediate layers 4 and the recording layers 5 is formed on the lower layer side of the selective reflection film 3. That is to say, the intermediate layers 4 and the recording layers 5 are laminated alternately in this order on the lower layer side of the selective reflection film 3.

For convenience of illustration, FIG. 1 illustrates the case where the five recording layers 5 (the six intermediate layers 4) are formed on the layer lower than the selective reflection film 3 (the layer corresponding to the related bulk layer 102). However, about several dozens (for example, about 20) of the recording layers 5 are actually formed in order to secure large recording capacity.

The intermediate layer 4 is made of a transparent material having light transparency. An example of the material of the intermediate layer 4 is a UV curing resin.

Further, the recording layer 5 becomes a layer in which first layers and second layers that are transparent and have slightly different refractive indexes are alternately laminated into a predetermined thickness.

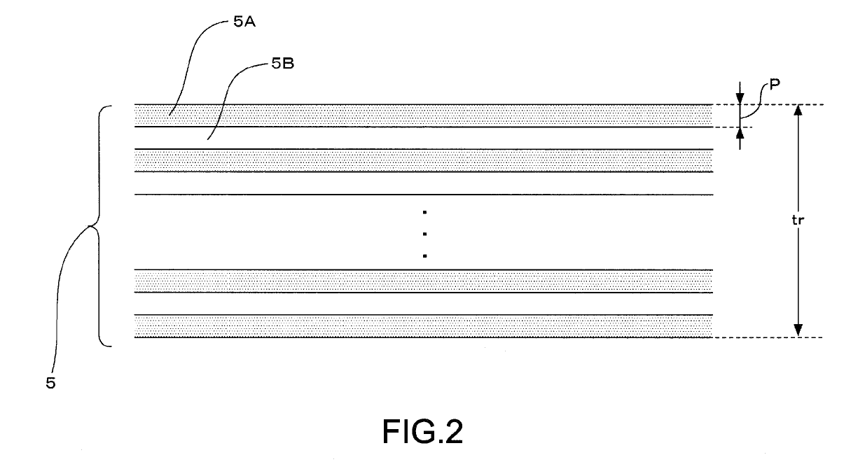

FIG. 2 is a cross-sectional structural diagram illustrating the recording layer 5.

In FIG. 2, the recording layer 5 is obtained by alternately laminating first refractive index setting layers 5A with a set first refractive index and second refractive index setting layers 5B with a set second refractive index slightly different from the first refractive index. A forming pitch P of the first refractive index setting layers 5A and the second refractive index setting layers 5B is constant. In other words, the first refractive index setting layers 5A and the second refractive index setting layers 5B have the same layer thickness.

The refractive index of the first refractive index setting layer 5A is set to a value different from that of the refractive index of the intermediate layer 4 shown in FIG. 1. On the other hand, the refractive index of the second refractive index setting layer 5B is set to the same value as that of the refractive index of the intermediate layer 4.

Specifically, in this example, the refractive index of the intermediate layer 4 and the second refractive index setting layer 5B is set to, for example, 1.50. On the contrary, the refractive index of the first refractive index setting layer 5A is set to, for example, 1.52. Therefore, a difference in the refractive index (Δn) between the first refractive index setting layer 5A and the second refractive index setting layer 5B in the recording layer 5 in this case becomes 0.02.

When the refractive indexes of the respective layers are set as above and the lower layer side of the selective reflection film 3 is the bulk layer, from a view of the entire negative type recording medium 1 shown in FIG. 1, only the refractive index of the first refractive index setting layer 5A in the recording layer 5 in the bulk layer is 1.52, and the refractive index of the other portions is 1.50.

The recording layer 5 has the structure such that the first refractive index setting layers 5A and the second refractive index setting layers 5B having slightly different refractive indexes are alternately laminated at the predetermined pitch P. Due to such a structure, the recording layer 5 functions as a diffraction grating. Specifically, when a laser beam is emitted to be focused onto the recording layer 5, the recording layer 5 functions as a reflector.

In this embodiment, the forming pitch P of the first refractive index setting layers 5A and the second refractive index setting layers 5B in the recording layer 5 (namely, the grating pitch P of the diffraction grating) and a thickness tr of the recording layer 5 are supposed to be set to numerical values corresponding to the microhologram (diffraction grating) formed in related positive type microhologram systems.

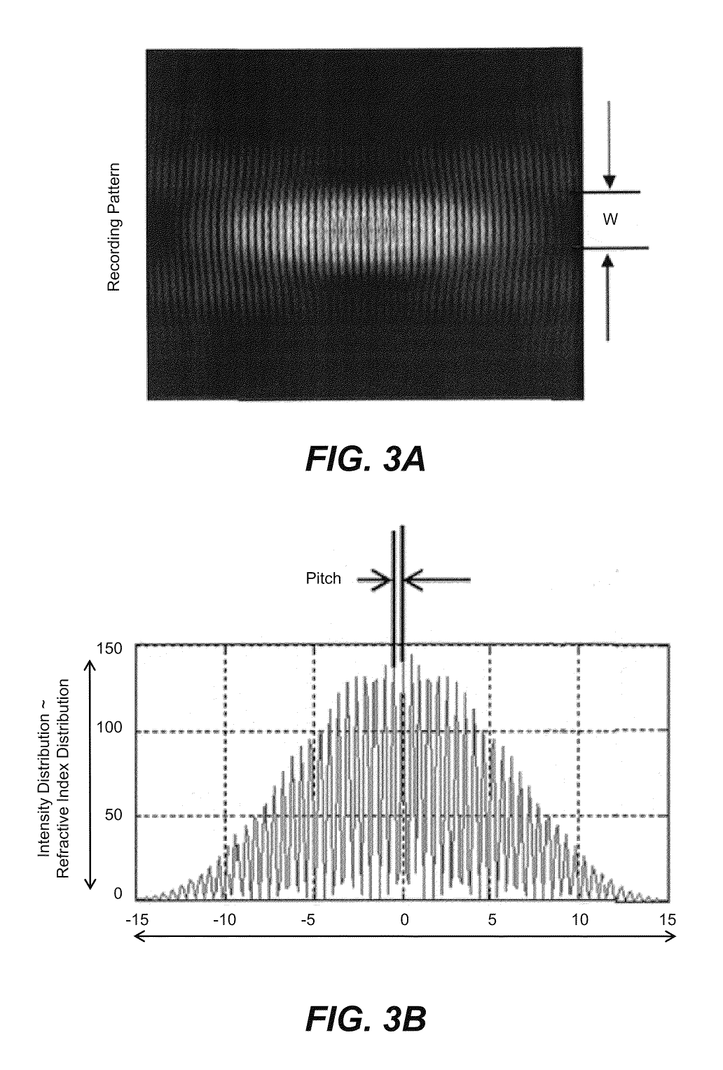

FIGS. 3A and 3B are diagrams for describing the microhologram (recording mark) to be recorded in the positive type microhologram system. FIG. 3A illustrates a pattern of the microhologram recording mark, and FIG. 3B illustrates a distribution of its refractive index (intensity distribution).

When the mark is recorded by the positive type microhologram system, a width w of the recording mark shown in FIG. 3A is determined by NA of an objective lens to be an output end of recording light and a wavelength λ of the recording light. Specifically, the width w is expressed as follows.

w=λ/NA

The applicant conducts an experiment on the positive type microhologram system with NA of the objective lens being set to 0.85 and the wavelength λ being set to 400 nm. These numerical values are approximately similar to those of current BD (Blu-ray Disc) systems.

Due to these settings of NA and λ, in the related positive type microhologram systems, the width w of the recording mark is set to about 0.47 μm.

In the positive type microhologram system, the refractive index distribution of the diffraction grating formed as the recording mark is as shown in FIG. 3B.

A length L in a depth direction of the recording mark shown in FIG. 3B (hereinafter, referred to as a mark depth L) is obtained by the following formula.

L=4λn/NA⁴

In the above formula, n represents the refractive index of the bulk layer formed with the recording mark.

In the related positive type microhologram systems, the refractive index n of the bulk layer is set to about 1.50, and thus the mark depth L is about 3.3 μm in the related positive type microhologram systems.

The grating pitch of the recording mark shown as “Pitch” in FIG. 3B is obtained by the following formula.

Pitch=λ/2n

Therefore, according to the condition that λ=400 nm and n=1.50 set in the related positive type microhologram systems exemplified above, the grating pitch becomes about 0.13 μm.

In the related positive type microhologram systems, the grating pitch of the recording mark (diffraction grating) is about 0.13 μm. Accordingly, also in the negative type recording medium 1 according to this embodiment, the forming pitch P of the first refractive index setting layers 5A and the second refractive index setting layers 5B in the recording layer 5, namely, the thickness of the first refractive index setting layer 5A and the second refractive index setting layer 5B is set to 0.13 μm.

At this time, since the mark depth L of the related microhologram recording marks is about 3.3 μm, the number of layers in the recording layer 5 may be about 26 because of 3.3 μm/0.13 μm. For example, in this embodiment, the number of layers in the recording layer 5 is 26, and thus the thickness tr of the recording layer 5 is about 3.38 μm.

The number of layers in the recording layer 5 and the thickness tr of the recording layer 5 influence the intensity of a reproduced signal, and simultaneously restrict the depth direction of the recording mark (deletion mark). That is to say, when an inter-layer crosstalk is repressed, it is occasionally desirable to reduce the number of layers in the recording layer 5 and the thickness tr thereof.

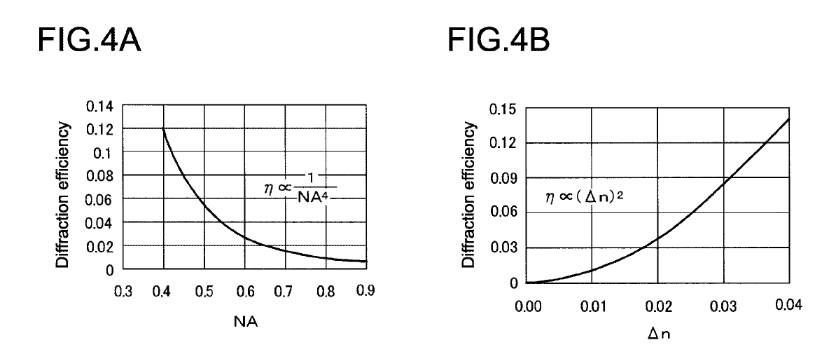

FIGS. 4A and 4B are diagrams for describing the diffraction efficiency of the microhologram recording mark. FIG. 4A illustrates a relationship between NA (numerical aperture) and the diffraction efficiency (η) of the objective lens, and FIG. 4B illustrates a relationship between the refractive index difference Δn and the diffraction efficiency η.

FIG. 4A shows a result when Δn=0.02 and the bulk layer refractive index=1.55, and FIG. 4B shows a result when NA=0.55 and λ=405 nm.

As shown in FIG. 4A, the diffraction efficiency η is inversely proportional to NA.

An attention should be paid to that the diffraction efficiency η is proportional to the refractive index difference Δn in the diffraction grating as shown in FIG. 4B.

In the example that adopts the negative type microhologram system, the large diffraction efficiency of the diffraction grating as the recording layer 5 means that it is in danger of being more difficult for a laser beam to reach the recording layers 5 formed on a lower side.

Therefore, in this embodiment, the refractive index difference Δn between the first refractive index setting layer 5A and the second refractive index setting layer 5B in the recording layer 5 is set so as to be very small.

When the refractive index difference Δn between the respective layers in the recording layer 5 is set to be very small, the negative type microhologram system can be advantageous to an increase in the number of recording layers.

The above description will be confirmed. In the positive type microhologram system, since two beams are condensed and the diffraction grating as the recording mark is formed, light of an equivalent incident angle to that of light emitted at the time of recording is emitted to the diffraction grating formed in such a manner at the time of reproducing so that diffracted light (reflected light) is generated (according to the Bragg's law).

On the contrary, in the diffraction grating formed by lamination like this example, its Brag selectivity tends to be weakened in comparison with the diffraction grating formed by the positive type microhologram system. For this reason, in the negative type microhologram system, when the refractive index difference Δn is large, a laser beam is in danger of hardly reaching the recording layers 5 formed on the lower layer side as described above.

The description returns to FIG. 1.

In the negative type recording medium 1 according to this embodiment, the intermediate layer 4 is inserted between the recording layer 5 and the recording layer 5.

In this embodiment, the thickness of the intermediate layer 4 is set to 10 μm or more. This prevents a crosstalk between the recording layers 5.

Specifically in this example, the thickness of the intermediate layer 4 is 10 μm.

### 1-2. Deletion Mark and Reproduced Signal

A laser beam is emitted to the negative type recording medium 1 according to this embodiment with the laser beam being focused on the recording layer 5 as a target for the recording. As a result, the deletion mark is recorded on this recording layer 5.

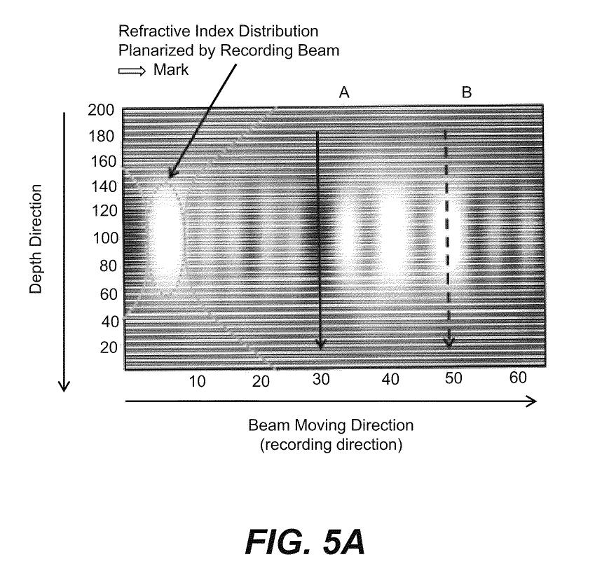

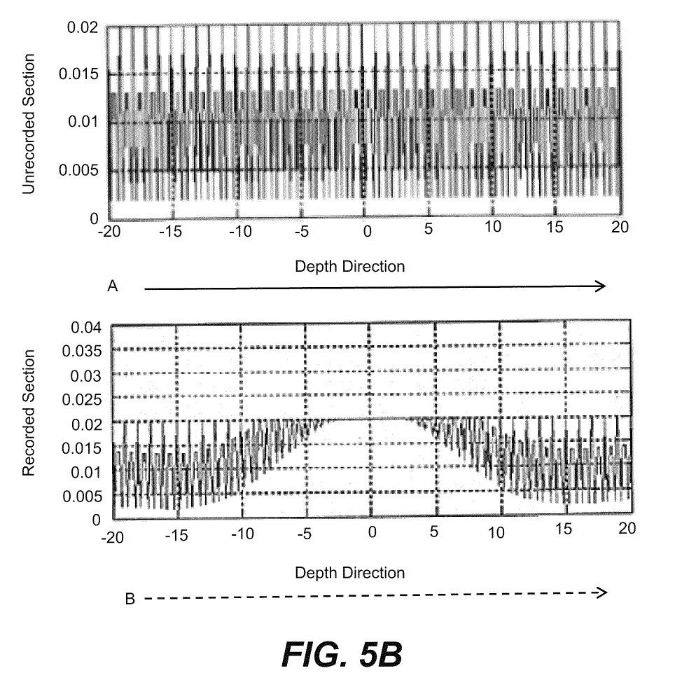

FIGS. 5A and 5B are diagrams for describing the deletion mark formed on the recording layer 5 by the emission of the laser beam.

FIG. 5A is a diagram illustrating a state of the recording layer 5 when a laser beam is switched between an ON state and an OFF state to be continuously emitted to the recording layer 5. FIG. 5B illustrates a refractive index distribution on a deletion mark formed portion (arrow A in FIG. 5A) and a deletion mark unformed portion (arrow B in FIG. 5A) that are formed on the recording layer 5 by the continuous emission of the laser beam.

In FIGS. 5A and 5B, when the laser beam is focused on the recording layer 5 to be emitted thereto and a laser beam condensed portion is heated to high temperature, the first refractive index setting layers 5A and the second refractive index setting layers 5B are mixed. As a result, the refractive index distribution on the recording layer 5 is planarized. Specifically, in the laser beam condensed portion, the refractive indexes of the first refractive index setting layers 5A (n=1.52) and the second refractive index setting layers 5B (n=1.50) change so as to get close to each other. As a result, the refractive index on the laser beam condensed portion is changed to their intermediate value (n=1.51).

On the portion where the refractive index distribution is planarized, a reflection rate is decreased more than the other portion of the recording layer 5 (the portion having the refractive index difference Δn). As a result, a so-called deletion mark is formed on the laser beam condensed portion.

At this time, the refractive index distribution is planarized by the emission of the laser beam so as to be a necessary distribution in a depth direction as shown in the refractive index distribution of the recording section (the portion B in FIG. 5A) shown on the right side of FIG. 5B. Specifically, the refractive index distribution is planarized so that the peak is in a vicinity of the laser beam focus position.

FIG. 5B illustrates only the distribution in the depth direction for convenience of illustration, but a distribution is generated around the focus position similarly to a recording direction (beam moving direction).

In FIG. 5B, the distribution of the deletion mark (the above planarized portion) is calculated as a distribution that is proportional to the light intensity squared of the laser beam.

The deletion mark as described above is formed by emitting the laser beam to the recording layer 5.

A forming degree of the deletion mark formed in such a manner varies with the light intensity (power) of the laser beam to be emitted.

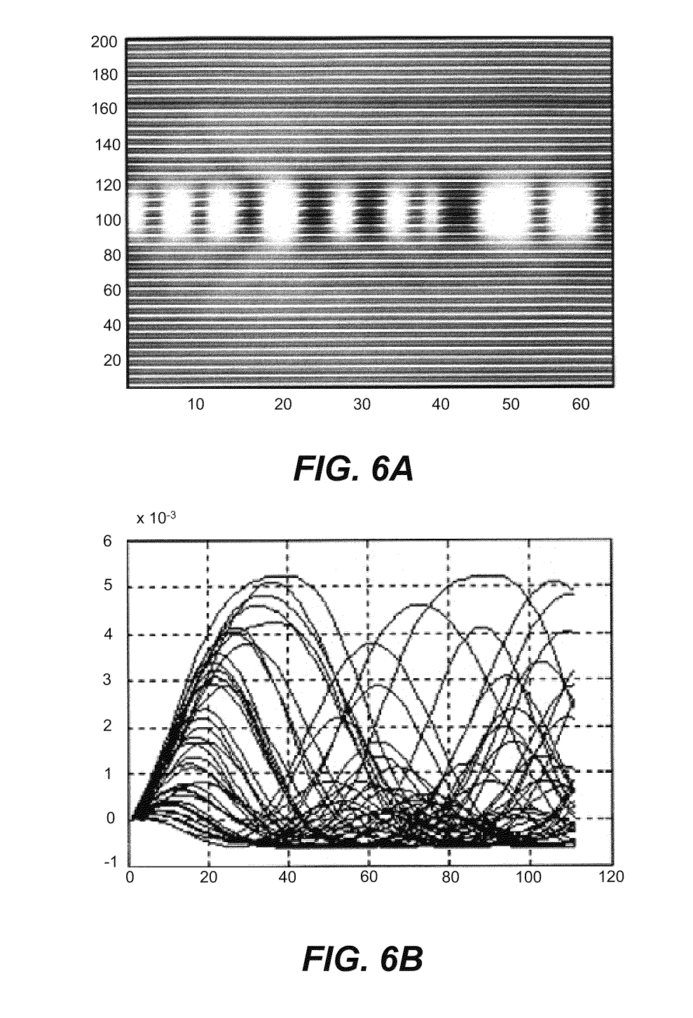

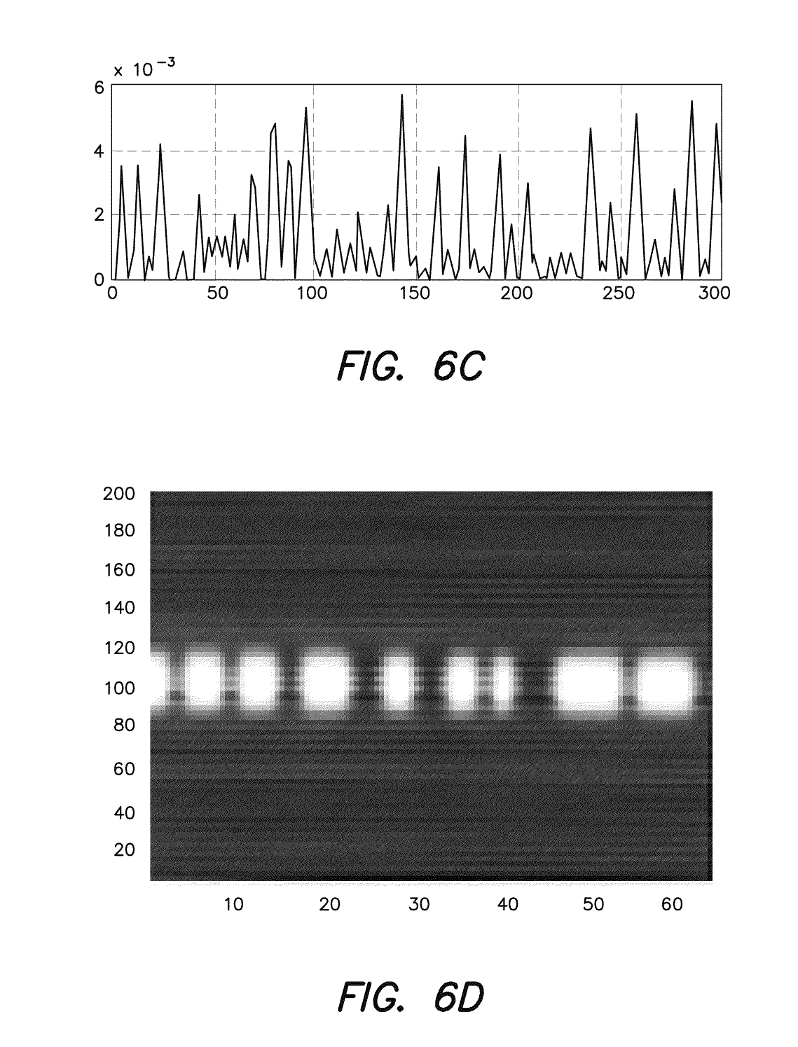

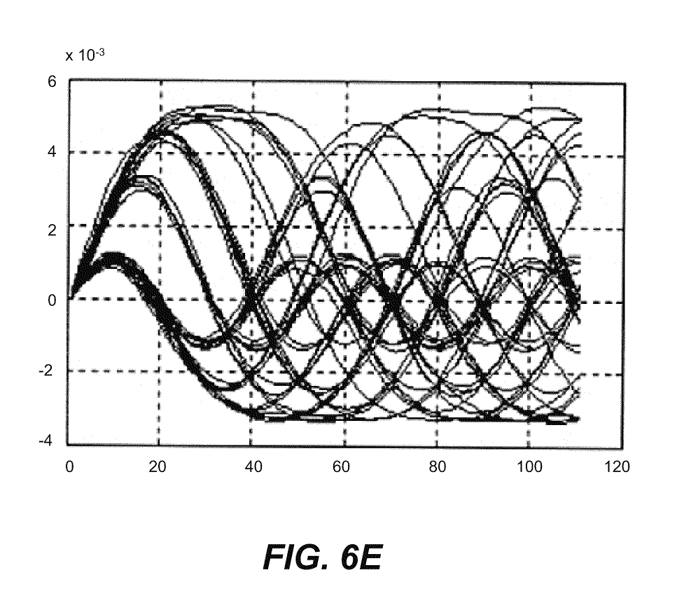

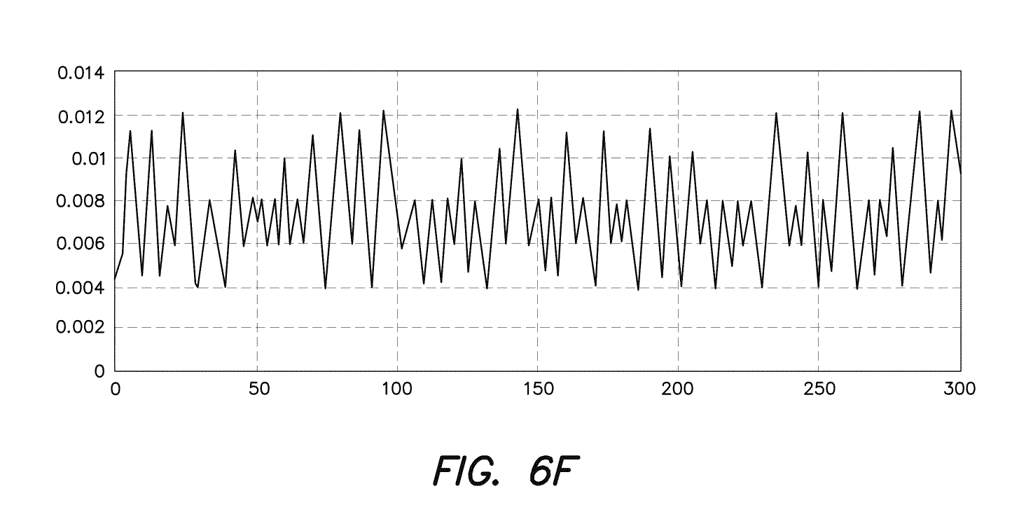

FIGS. 6A to 6F are diagrams illustrating a comparison between the deletion mark and its reproduced signal when recording is performed by using laser beams having different light intensities.

FIGS. 6A to 6C on the left side illustrate results when the recording is performed with a certain light intensity α, and FIGS. 6D to 6F on the right side illustrate results when the recording is performed with a light intensity β that is stronger than the light intensity α.

FIGS. 6A and 6D illustrate states of the formed deletion mark, and FIGS. 6B and 6E illustrate eye patterns of the reproduced signal of the recorded deletion mark. FIGS. 6C and 6F illustrate reproduced signal waveforms.

When the light intensity of the laser beam becomes stronger, a base portion of the distribution on the planarized portion shown in FIG. 5B tends to be precipitous. That is to say, if the distribution on the planarized portion shown in FIG. 5B is obtained at the time when the recording is performed with the light intensity α, when recording is performed with larger light intensity β, a tilt of the base portion of the distribution is more precipitous than that shown in FIG. 5B.

For this reason, when FIG. 6A is compared with FIG. 6D, an edge portion of the deletion mark in FIG. 6D recorded with the larger light intensity β is enhanced more than that of the deletion mark in FIG. 6A recorded with the light intensity α.

As the light intensity becomes stronger, a clearer deletion mark is formed. As a result, when the light intensity is stronger, a more satisfactory reproduced signal can be obtained.

Specifically, in FIG. 6E where the recording is performed with the light intensity β, the eye pattern is clearer than that in FIG. 6B where the recording is performed with the light intensity α.

When the reproduced signal waveforms in FIGS. 6C and 6F are compared, a waveform whose amplitude becomes large and small based on a necessary center level is obtained in FIG. 6F where the recording is performed with the light intensity β. That is to say, the satisfactory waveform in FIG. 6F that is more suitable for binarizing than that in FIG. 6C is obtained.

### 2. Method of Manufacturing Optical Recording Medium

The method of manufacturing the negative type recording medium 1 shown in FIG. 1 is described below.

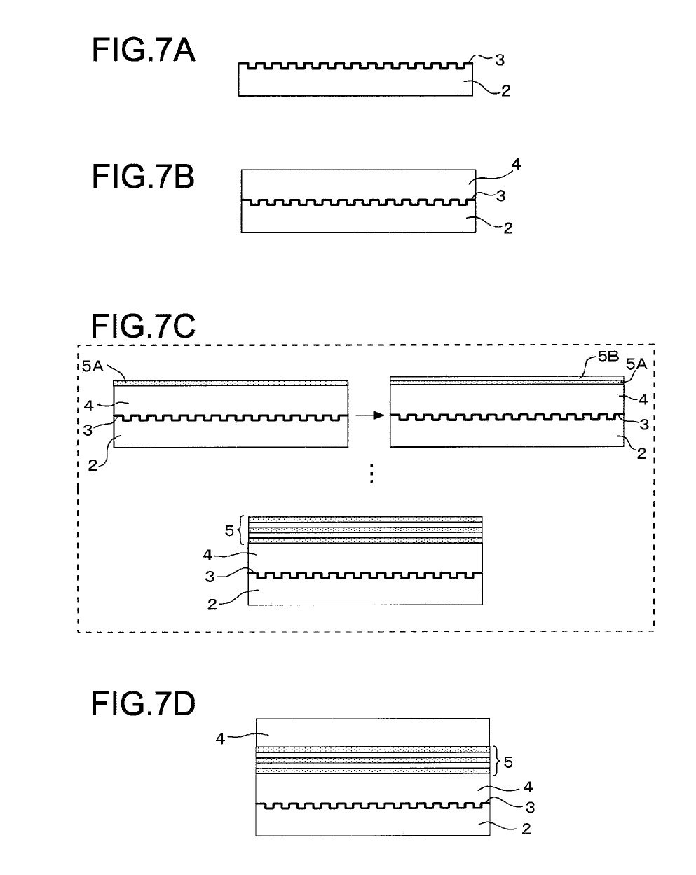

FIGS. 7A to 7D are diagrams for describing a first manufacturing method.

At first, when the negative type recording medium 1 is manufactured, the cover layer 2 that is formed with the race on its one surface is generated by the injection molding using a stamper as described above at a step of generating the cover layer 2.

The selective reflection film 3 is then deposited on the surface of the cover layer 2 formed with the race by sputtering or vacuum evaporation, for example, at a step of depositing the reflection film (FIG. 7A).

After the selective reflection film 3 is deposited on the cover layer 2, as shown in FIG. 7B, the intermediate layer 4 is laminated on the selective reflection film 3. In this case, the selective reflection film 3 is spin-coated with a UV curing resin as the intermediate layer 4 at a step of laminating the intermediate layer 4. Thereafter, an ultraviolet ray is emitted so that the UV curing resin is cured, and the intermediate layer 4 is formed.

After the intermediate layer 4 is laminated, the first refractive index setting layers 5A and the second refractive index setting layers 5B are alternately laminated on the intermediate layer 4 at a predetermined number of times at a step of forming the recording layer shown in FIG. 7C. For convenience of the drawing, FIG. 7C illustrates the case where the recording layer 5 includes five layers (the three first refractive index setting layers 5A and the two second refractive index setting layers 5B). However, as is understood from the above description, the number of layers to be formed in the recording layer 5 in this example is actually about 26.

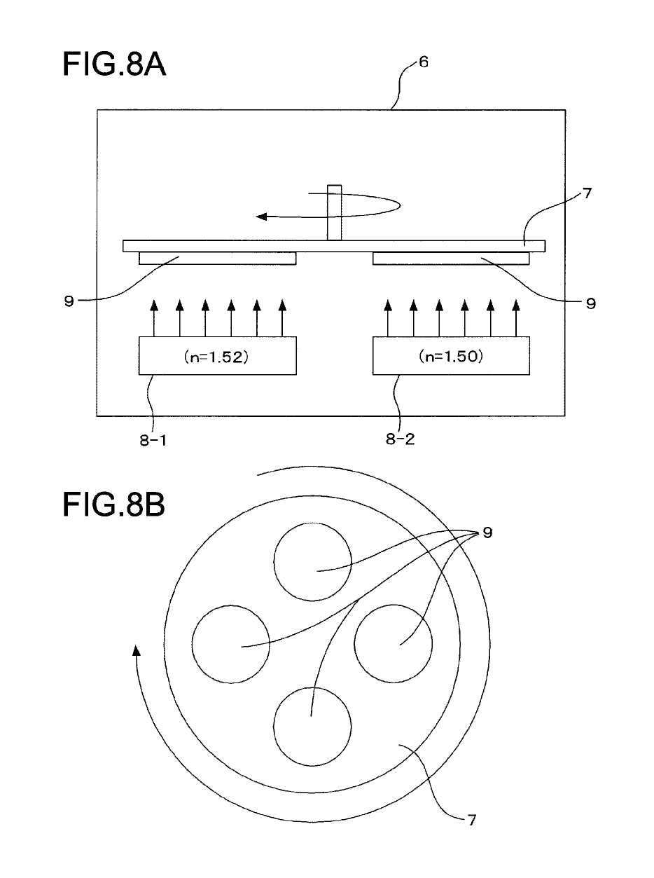

According to the above description, the thicknesses of the first refractive index setting layers 5A and the second refractive index setting layers 5B in this example are set to about 0.13 μm that is comparatively thin. As the method advantageous to the lamination of the comparatively thin first refractive index setting layers 5A and second refractive index setting layers 5B, a laminating method shown in FIGS. 8A and 8B is adopted at the step of forming the recording layer in this case.

At the step of forming the recording layer in this case, the first refractive index setting layers 5A and the second refractive index setting layers 5B are laminated by a so-called vacuum deposition method using a vacuum chamber 6 as shown in FIG. 8A. Specifically, in this case, the first refractive index setting layers 5A and the second refractive index setting layers 5B are laminated by a sputtering method.

A rotary tray 7 is provided into the vacuum chamber 6 as shown in the drawing, and a plurality of laminate discs 9 where the intermediate layers 4 are laminated is set on the rotary tray 7.

FIG. 8B illustrates a state where the plurality of laminate discs 9 is set on the rotary tray 7, but as shown in FIG. 8B, the four laminate discs 9 are set on the rotary tray 7 in this case with the discs 9 being sufficiently separated from each other so that respective arrangement positions do not overlap.

Return to FIG. 8A, a first target 8-1 as a forming material of the first refractive index setting layer 5A and a second target 8-2 as a forming material of the second refractive index setting layer 5B are arranged at positions in the vacuum chamber 6 that are opposed to the laminate discs 9 set on the rotary tray 7.

As shown in the drawing, in this example, a refractive index n of the first target 8-1 is 1.52, and a refractive index n of the second target 8-2 is 1.50.

In order to accurately control such a slight refractive index difference, in this example, the materials of the first target 8-1 and the second target 8-2 are selected as follows.

For example in a field of optical fibers, about several percentages of the refractive index difference should be given to a core and a clad in order to propagate light confined in a fiber line. For this reason, silica glass is used as base materials of the core and clad, Ge (germanium) or P (phosphorus) is added to the core in order to heighten the refractive index, and B (boron) or F (fluorine) is added to the clad in order to lower the refractive index.

Following the above, in this example, Ge or P is added to the silica glass as the first target 8-1 (the first refractive index setting layers 5A), and B or F is added to the silica glass as the second target 8-2 (the second refractive index setting layers 5B). In such a manner, the materials whose refractive indexes are accurately controlled to a predetermined value are used.

In this case, the respective layers are deposited on the laminate discs 9 in the following manner.

It is assumed that the vacuum chamber 6 is charged with inactive gas such as argon gas. In this case, the rotary tray 7 is rotated, and the target laminate disc 9 is arranged at the position opposed to the first target 8-1, and a DC high voltage is applied between the target laminate disc 9 and the first target 8-1. As a result, the material as the first target 8-1 adheres to the target laminate disc 9, with the result that the first refractive index setting layer 5A is laminated.

Also in the subsequent steps, the rotary tray 7 is rotated, and the remaining laminate discs 9 on the rotary tray 7 are successively arranged at the position opposed to the first target 8-1, and a voltage is applied thereto. As a result, the first refractive index setting layers 5A are deposited on the laminate discs 9.

After the first refractive index setting layers 5A are laminated on all the laminate discs 9 on the rotary tray 7, the rotary tray 7 is rotated so that the respective laminate discs 9 are sequentially arranged at the position opposed to the second target 8-2, and simultaneously a voltage is applied thereto. As a result, the material as the second target 8-2 is allowed to adhere to the respective laminate discs 9, with the result that the second refractive index setting layers 5B are laminated.

The materials as the first target 8-1 and the second target 8-2 are deposited alternately and repeatedly at a predetermined number of times. As a result, the recording layer 5 where the necessary number of first refractive index setting layers 5A and second refractive index setting layers 5B are laminated is formed (generated).

Return to FIGS. 7A to 7D, after the recording layer forming step in FIG. 7C is executed, as shown in FIG. 7D, the intermediate layer 4 is laminated on the formed recording layer 5 by the method similar to that described with reference to FIG. 7B.

Though not shown in the drawing, after the intermediate layer laminating step in FIG. 7D, the recording layer forming step and the intermediate layer forming step are alternately repeated at a predetermined number of times. As a result, as shown in FIG. 1, the negative type recording medium 1 where the necessary number of intermediate layers 4 and recording layers 5 are laminated alternately is manufactured.

The above description gives an example using the silica glass as the base materials of the first refractive index setting layers 5A and the second refractive index setting layers 5B, but this is only example of a realizable material, and thus other materials can be used.

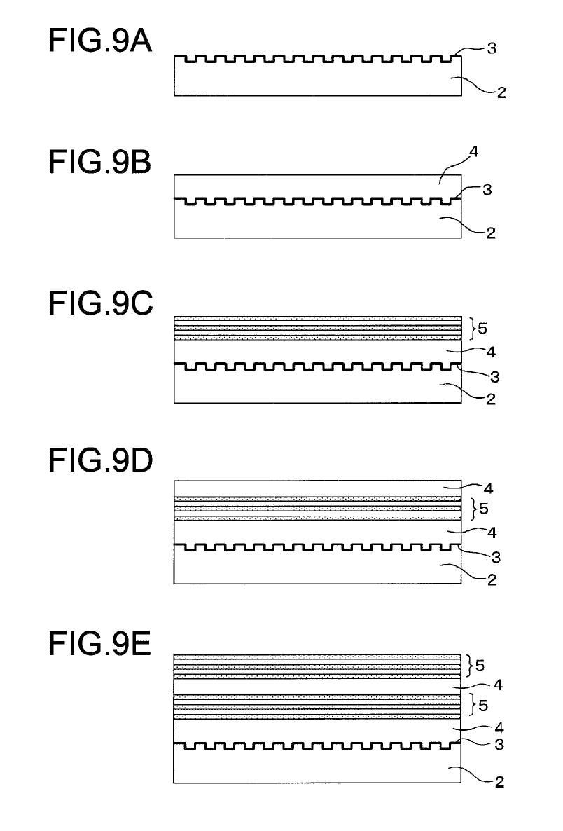

FIGS. 9A to 9E are diagrams illustrating a manufacturing method (second manufacturing method) that copes with the case where a resin material is used as the materials of the first refractive index setting layers 5A and the second refractive index setting layers 5B.

In this case, the generation of the cover layer 2 and the reflection film depositing step shown in FIG. 9A are similar to those in FIG. 7A. Further, the intermediate layer laminating step shown in FIG. 9B is similar to that in FIG. 7B.

In this case, at the recording layer forming step shown in FIG. 9C, the first refractive index setting layers 5A and the second refractive index setting layers 5B as the resin materials are laminated alternately at a predetermined number of times by spin coating. Specifically, the intermediate layer 4 is spin-coated with a UV curing resin having the refractive index as the first refractive index setting layer 5A, and then an ultraviolet ray is emitted thereto. Further, the laminated first refractive index setting layer 5A is similarly spin-coated with a UV curing resin having the refractive index as the second refractive index setting layer 5B, and then an ultraviolet ray is emitted thereto. The first refractive index setting layer 5A and the second refractive index setting layer 5B are repeatedly laminated by the spin coating and the emission of ultraviolet rays at the predetermined number of times, with the result that the recording layer 5 having a predetermined number of layers is formed.

After the recording layer 5 is formed in the above manner, the intermediate layer laminating step is performed so that the intermediate layer 4 is laminated on the recording layer 5 (FIG. 9D). Thereafter, the recording layer forming step is performed according to the method similar to the method in FIG. 9C, with the result that the recording layer 5 is formed on the intermediate layer 4 (FIG. 9E).

The intermediate layer laminating step and the recording layer forming step are repeated at a predetermined number of times, with the result that the negative type recording medium 1 shown in FIG. 1 is manufactured.

### 3. Effect of Optical Recording Medium According to Embodiment

As described above, the negative type recording medium 1 according to this embodiment is provided with the recording layer using the diffraction grating that is formed by alternately laminating the transparent first and second layers having slightly different refractive indexes in advance. As a result, the initializing process for forming the recording layer that is executed in related negative type microhologram systems can be eliminated.

When the initializing process for forming the recording layer (diffraction grating) can be eliminated, the time up to the start of recording is greatly shortened accordingly.

The elimination of the initializing process can solve problems relating to the power of initializing light and record sensitivity of the bulk layer in related negative type microhologram systems.

With the negative type recording medium 1 according to this embodiment, the problems in the related negative type microhologram systems can be solved, and thus the feasibility of a multi-layer recording medium (large-capacity recording medium) using the negative type microhologram system can be further heightened.

### 4. Servo Control

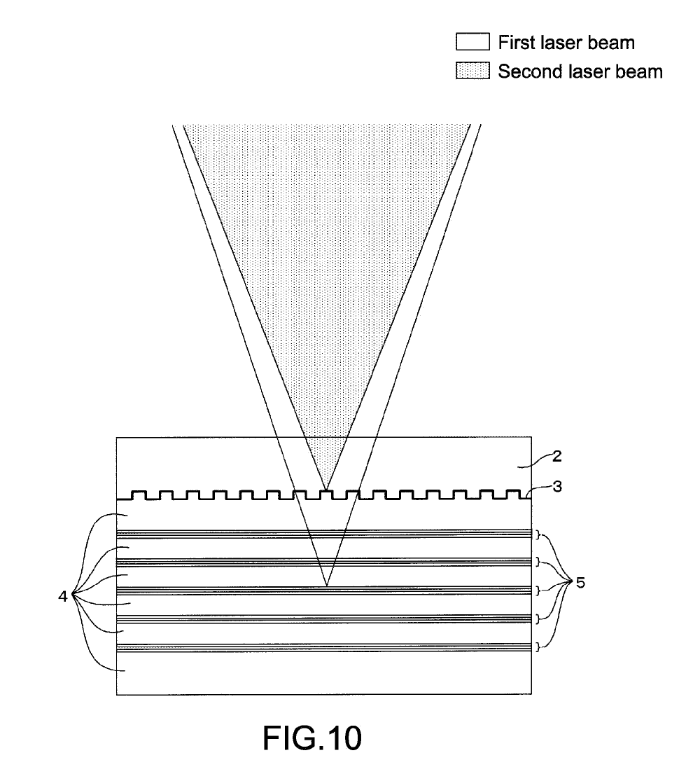

Servo control at the time of recording/reproducing using the negative type recording medium 1 according to this embodiment is described below with reference to FIG. 10.

In FIG. 10, in the bulk recording system, recording light (first laser beam) for recording a mark and servo light (second laser beam) for obtaining error signals of tracking and focus based on the race are separately emitted to the bulk layer as the recording layer, as described above.

As described later, the first laser beam and the second laser beam are emitted to the negative type recording medium 1 via a common objective lens.

In the negative type recording medium 1, the recording layer 5 that is the target position for recording of the deletion mark is simply a layer to which the refractive index difference Δn is given and in which a race is not formed by a pit or a groove. For this reason, in the recording with the deletion mark not yet formed, tracking servo using the first laser beam is not performed.

From this point, the tracking servo at the time of recording is performed by using the second laser beam. That is to say, a tracking error signal is generated based on a reflected light of the second laser beam focused on the selective reflection film 3, and the position of the objective lens in a tracking direction is controlled based on the tracking error signal.

On the other hand, at the time of recording, the focus servo is performed by using the first laser beam.

That is to say, the intensity of the reflected light of the first laser beam differs between the state where the first laser beam is focused on the recording layer 5 and the state where the first laser beam is focused on portions other than the recording layer 5. With utilization of this point, the focus servo is controlled by using the reflected light of the first laser beam.

Both the tracking servo and the focus servo are performed by using the reflected light of the first laser beam at the time of reproducing from the negative type recording medium 1 where the deletion mark is already recorded. In other words, the emission of the second laser beam at the time of reproducing can be omitted.

According to the above description, the first laser beam and the second laser beam are emitted to the negative type recording medium 1 via the common objective lens. Accordingly, at the time of recording, a spot position of the first laser beam in the tracking direction is automatically controlled by controlling the position of the objective lens based on the reflected light of the second laser beam. In other words, the common objective lens is driven based on the tracking error signal generated based on the reflected light of the second laser beam. As a result, the tracking servo control that is performed based on the reflected light of the second laser beam equally acts on the first laser beam side.

An attention should be paid to that the focus position of the first laser beam and the focus position of the second laser beam need to be different from each other in the focus direction. That is to say, as understood with reference to FIG. 10, the focus position of the second laser beam should match with the selective reflection film 3 so that the tracking error signal is suitably generated based on the reflected light from the selective reflection film 3 formed with a convexo-concave shape due to the race. On the other hand, the focus position of the first laser beam should be set on the recording layer 5 as a target for the recoding.

When this point is taken into consideration, the first laser beam and the second laser beam should be independently controlled in the focus direction.

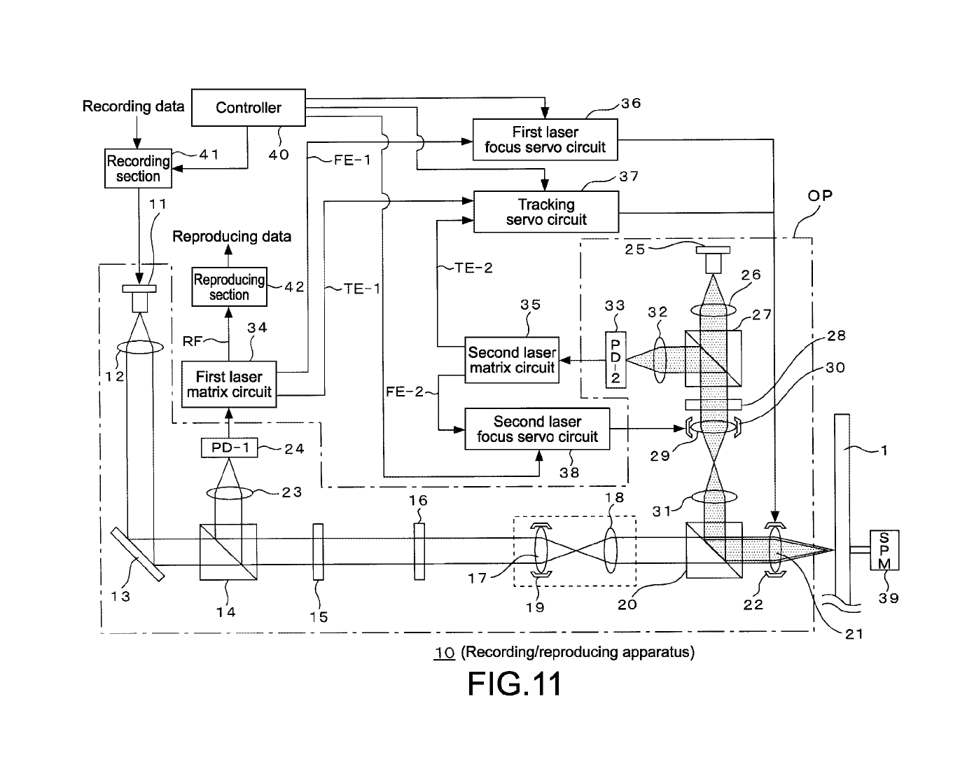

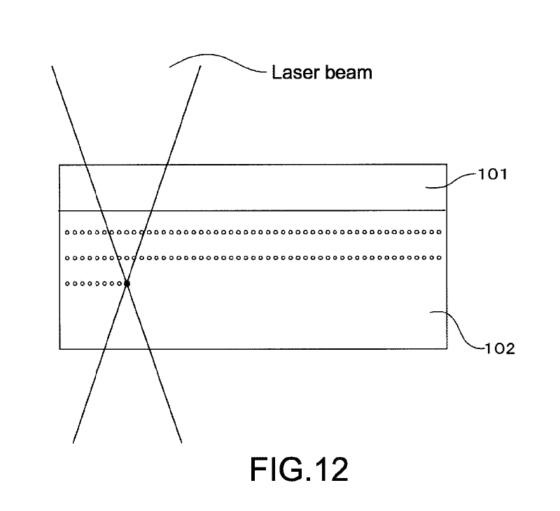

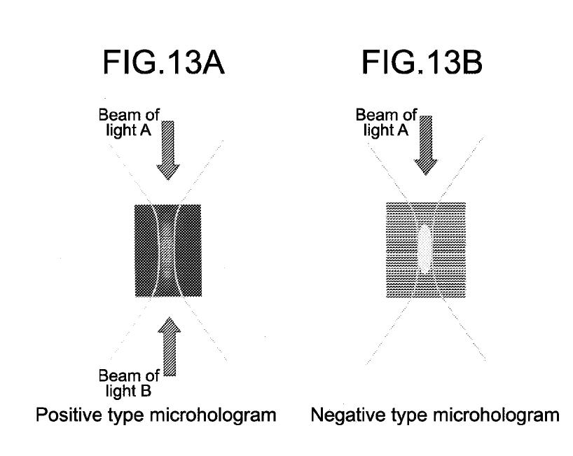

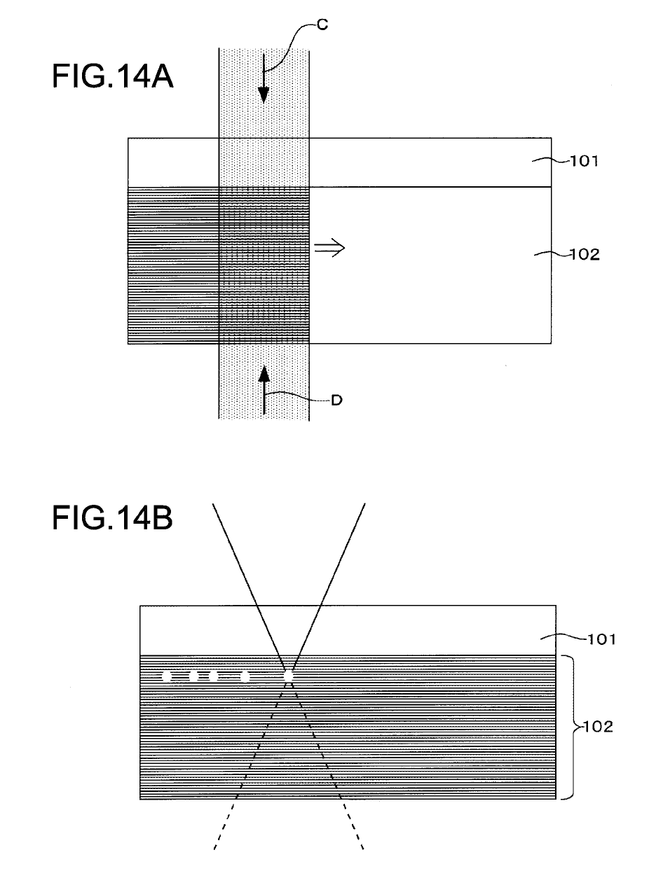

The focus of the first laser beam in this case is controlled by using the reflected light of the first laser beam at both the recording and the reproducing. When this point is taken into consideration, in this example, the focus of the first laser beam is controlled by driving the common objective lens. The focus of the second laser beam is controlled by separately providing a mechanism for independently controlling the focus position of the second laser beam and driving the mechanism (corresponding to a second laser focus mechanism 30 in FIG. 11).

When the above description is summarized, the servo control according to this embodiment is performed in the following manner.

First Laser Beam Side

At the time of recording: the focus servo is performed by driving the objective lens using the reflected light of the first laser beam (the tracking servo is automatically performed by driving the objective lens using the reflected light of the second laser beam).

At the time of reproducing: both the focus servo and the tracking servo are performed by driving the objective lens using the reflected light of the first laser beam.

Second Laser Beam Side

At the time of recording: the focus servo is performed by driving the second laser focus mechanism using the reflected light of the second laser beam, and the tracking servo is performed by driving the objective lens using the reflected light of the second laser beam.

At the time of reproducing: the emission of the second laser beam can be eliminated.

### 5. Structure of Recording/Reproducing Apparatus

FIG. 11 illustrates an internal structure of a recording/reproducing apparatus 10 for recording on and reproducing from the negative type recording medium 1 shown in FIG. 1.

At first, the negative type recording medium 1 mounted to the recording/reproducing apparatus 10 is driven to be rotated by a spindle motor (SPM) 39 in the drawing.

The recording/reproducing apparatus 10 is provided with an optical pickup OP that emits the first laser beam and the second laser beam to the negative type recording medium 1 driven to be rotated in such a manner.

The optical pickup OP includes a first laser 11 and a second laser 25. The first laser 11 is a light source of the first laser beam for recording information using a deletion mark and reproducing information recorded by the deletion mark. The second laser 25 is a light source of the second laser beam as the servo light.

As described above, the first laser beam and the second laser beam have different wavelengths. In this example, the wavelength of the first laser beam is about 400 nm (so-called, bluish-purple laser beam), and the wavelength of the second laser beam is about 650 nm (red laser beam).

The optical pickup OP includes an objective lens 21 to be an output end of the negative type recording medium 1 for the first laser beam and the second laser beam.

Further, the optical pickup OP includes a first photodetector (in the drawing, PD-1) 24 and a second photodetector (in the drawing, PD-2) 33. The first photodetector 24 receives the reflected light of the first laser beam from the negative type recording medium 1. The second photodetector 33 receives the reflected light of the second laser beam from the negative type recording medium 1.

The optical pickup OP is formed with an optical system that guides the first laser beam emitted from the first laser 11 to the objective lens 21 and guides the reflected light of the first laser beam from the negative type recording medium 1 incident on the objective lens 21 to the first photodetector 24.

Specifically, after the first laser beam emitted from the first laser 11 is converted into parallel light via a collimation lens 12, and its optical axis is bent 90° by a mirror 13 so that the parallel light is incident on a polarization beam splitter 14. The polarization beam splitter 14 transmits the first laser beam that is emitted from the first laser 11 and is incident thereon via the mirror 13.

The first laser beam transmitted through the polarization beam splitter 14 passes through a liquid crystal element 15 and a quarter wavelength plate 16.

The liquid crystal element 15 is provided for correcting so-called off-axis aberrations such as coma aberration and astigmatism.

The first laser beam that passes through the quarter wavelength plate 16 is incident on an expander including lenses 17 and 18. In the expander, the lens 17 is a movable lens, and the lens 18 is a fixed lens. When a lens driving section 19 in the drawing drives the lens 17 to a direction parallel with an optical axis of the first laser beam, spherical aberration of the first laser beam is corrected.

The first laser beam through the expander is incident on a dichroic mirror 20. The dichroic mirror 20 transmits light having the same wavelength band as that of the first laser beam, and reflects light having the other wavelengths. The first laser beam that is incident in such a manner transmits through the dichroic mirror 20.

The first laser beam that transmits through the dichroic mirror 20 is emitted to the recording medium 1 via the objective lens 21.

A biaxial mechanism 22 is provided for the objective lens 21. The biaxial mechanism 22 holds the objective lens 21 so that the objective lens 21 can shift in a focus direction (a direction that closes/separates to/from the negative type recording medium 1) and a tracking direction (a direction perpendicular to the focus direction: a radial direction of the negative type recording medium 1).

When a drive current is applied from a first laser focus servo circuit 36 and a tracking servo circuit 37 both of which will be described later to a focus coil and a tracking coil, the biaxial mechanism 22 shifts the objective lens 21 in the focus direction and the tracking direction.

When the first laser beam is emitted to the negative type recording medium 1 in the above manner, the reflected light of the first laser beam is obtained from the negative type recording medium 1. The reflected light of the first laser beam is guided to the dichroic mirror 20 via the objective lens 21, and transmits through the dichroic mirror 20.

After the reflected light of the first laser beam that transmits through the dichroic mirror 20 passes through the lens 18 and then the lens 17 in the expander, it is incident on the polarization beam splitter 14 via the quarter wavelength plate 16 and the liquid crystal element 15.

Polarizing directions are set to be different by 90° between the reflected light of the first laser beam (return light) that is incident on the polarization beam splitter 14 and the first laser beam (outward light) that is incident on the polarization beam splitter 14 from the first laser beam 11 side due to a function of the quarter wavelength plate 16 and a reflecting function of the negative type recording medium 1. As a result, the reflected light of the first laser beam that is incident in the above manner is reflected on the polarization beam splitter 14.

The reflected light of the first laser beam reflected on the polarization beam splitter 14 is condensed on a detecting surface of the first photodetector 24 via a condenser lens 23.

In the optical pickup OP, in addition to the structure of the optical system for the first laser beam, an optical system is formed. This optical system guides the second laser beam emitted from the second laser 25 to the objective lens 21, and guides the reflected light of the second laser beam from the negative type recording medium 1 that is incident on the objective lens 21 to the second photodetector 33.

As shown in the drawing, after the second laser beam emitted from the second laser 25 is converted into parallel light via a collimation lens 26, it is incident on a polarization beam splitter 27. The polarization beam splitter 27 transmits the second laser beam (outward light) that is incident via the second laser 25 and the collimation lens 26.

The second laser beam that transmits through the polarization beam splitter 27 is incident on a second laser focus lens 29 via a quarter wavelength plate 28.

As shown in the drawing, a second laser focus mechanism 30 is provided for the second laser focus lens 29. The second laser focus mechanism 30 holds the second laser focus lens 29 so as to be movable to a direction parallel with an optical axis of the second laser beam, and drives the second laser focus lens 29 according to application of a drive current to a focus coil provided into the mechanism 30.

The second laser beam via the second laser focus lens 29 is focused on a position corresponding to a drive state of the second laser focus mechanism 30. Thereafter, the second laser beam is converted into parallel light via a lens 31 and is incident on the dichroic mirror 20.

As described above, the dichroic mirror 20 transmits the light having the same wavelength band as that of the first laser beam, and reflects light having the other wavelengths. Therefore, the second laser beam is reflected on the dichroic mirror 20, and is emitted to the negative type recording medium 1 via the objective lens 21 as shown in the drawing.

The reflected light of the second laser beam obtained by emitting the second laser beam to the negative type recording medium 1 is reflected on the dichroic mirror 20 via the objective lens 21. The reflected light then passes through the lens 31, the second laser focus lens 29 and the quarter wavelength plate 28, and is incident on the polarization beam splitter 27.

Similarly to the case of the first laser beam, polarizing directions are set to be different by 90° between the reflected light of the second laser beam (return light) that is incident from the negative type recording medium 1 side and the outward light due to a function of the quarter wavelength plate 28 and the reflecting function of the negative type recording medium 1. Therefore, the reflected light of the second laser beam as the return light is reflected on the polarization beam splitter 27.

The reflected light of the second laser beam reflected on the polarization beam splitter 27 is condensed on a detecting surface of the second photodetector 33 via a condenser lens 32.

The description with reference to the drawing is omitted, but actually the recording/reproducing apparatus 10 is provided with a slide driving section for driving to slide the entire optical pickup OP to the tracking direction. The driving of the optical pickup OP using the slide driving section can shift the emitted position of a laser beam in a wide range.

Further, the recording/reproducing apparatus 10 is provided with a first laser matrix circuit 34, a second laser matrix circuit 35, a first laser focus servo circuit 36, a tracking servo circuit 37, a second laser focus servo circuit 38, a controller 40, a recording section 41, and a reproducing section 42 as well as the optical pickup OP and the spindle motor 39.

Data (recording data) to be recorded on the negative type recording medium 1 is input into the recording section 41. The recording section 41 adds an error correcting code to the input recording data or executing predetermined recording modulation encoding thereon so as to obtain a recording modulation data string as a binary data string of “0” and “1” to be actually recorded on the negative type recording medium 1.

The recording section 41 drives light emission of the first laser 11 based on the generated recording modulation data string according to an instruction from the controller 40.

Further, the first laser matrix circuit 34 has a current-voltage converting circuit, a matrix operating/amplifying circuit and the like correspondingly to output currents from a plurality of light receiving elements as the first photodetector 24, and generates a necessary signal according to the matrix operating process.

Specifically, the first laser matrix circuit 34 generates a high-frequency signal (hereinafter, referred to as a reproduced signal RF) corresponding to a reproduced signal of the recording modulation data string, a focus error signal FE for the servo control, and a tracking error signal TE.

In this example, the focus error signal FE and the tracking error signal TE include two kinds of them based on the reflected light of the first laser beam and the reflected light of the second laser beam. In order to distinguish both of them, hereinafter, the focus error signal FE generated by the first laser matrix circuit 34 is referred to as a focus error signal FE-1, and similarly the tracking error signal TE generated by the first laser matrix circuit 34 is referred to as a tracking error signal TE-1.

The reproduced signal RF generated by the first laser matrix circuit 34 is supplied to the reproducing section 42.

Further, the focus error signal FE-1 is supplied to the first laser focus servo circuit 36, and the tracking error signal TE-1 is supplied to the tracking servo circuit 37.

The reproducing section 42 executes reproducing processes for restoring the recording data such as a binarizing process, the recording modulation code decoding and an error correcting process on the reproduced signal RF generated by the first laser matrix circuit 34, so as to obtain reproduced data of the recording data.

The first laser focus servo circuit 36 generates a focus servo signal based on the focus error signal FE-1, and drives a focus coil of the biaxial mechanism 22 based on the focus servo signal, so as to control the focus servo of the first laser beam.

The first laser focus servo circuit 36 performs a jump operation between the recording layers 5 formed on the negative type recording medium 1 or draws focus servo for the necessary recording layer 5 according to an instruction from the controller 40.

The second laser matrix circuit 35 has a current-voltage converting circuit, a matrix operating/amplifying circuit and the like correspondingly to output currents from a plurality of light receiving elements as the second photodetector 33, and generates a necessary signal according to the matrix operating process.

Specifically, the second laser matrix circuit 35 generates a focus error signal FE-2 and a tracking error signal TE-2 for the servo control.

The focus error signal FE-2 is supplied to the second laser focus servo circuit 38, and the tracking error signal TE-2 is supplied to the tracking servo circuit 37.

The second laser focus servo circuit 38 generates a focus servo signal based on the focus error signal FE-2, and drives the second laser focus mechanism 30 based on the focus servo signal, so as to control the focus servo of the second laser beam.

At this time, the second laser focus servo circuit 38 draws the focus servo to the selective reflection film 3 (the race formed surface) formed on the negative type recording medium 1 according to an instruction from the controller 40.

The tracking servo circuit 37 generates a tracking servo signal based on any one of the tracking error signal TE-1 from the first laser matrix circuit 34 and the tracking error signal TE-2 from the second laser matrix circuit 35 according to an instruction from the controller 40. The tracking servo circuit 37 drives the tracking coil of the biaxial mechanism 22 based on the tracking servo signal. That is to say, as to the position control of the objective lens 21 in the tracking direction, any one of the tracking servo control based on the reflected light of the first laser beam and the tracking servo control based on the reflected light of the second laser beam is performed.

The controller 40 includes a microcomputer having a memory (storage device) such as CPU (Central Processing Unit) and ROM (Read Only Memory). The controller 40 executes control and processes according to programs stored in the ROM, for example, so as to control the entire recording/reproducing apparatus 1.

Specifically, at the time of recording, the controller 40 instructs the first laser focus servo circuit 36 to focus the first laser beam on the necessary recording layer 5 (namely, with the focus servo on the necessary recording layer 5 being controlled) and then instructs the recording section 41 to perform recording. As a result, the controller 40 allows the recording section 41 to form a deletion mark on the recording layer 5 according to the recording data. That is to say, the information recording operation is performed by forming the deletion mark.

As described before, the tracking servo control at the time of recording should be made based on the reflected light of the second laser beam. For this reason, the controller 40 instructs the tracking servo circuit 37 to make the tracking servo control based on the tracking error signal TE-2 at the time of recording.

At the time of recording, the controller 40 instructs the second laser focus servo circuit 38 to make the focus servo control.

On the other hand, at the time of reproducing, the controller 40 instructs the first laser focus servo circuit 36 to focus the first laser beam on the recording layer 5 on which the data to be reproduced is recorded. That is to say, the focus servo relating to the first laser beam is controlled on the recording layer 5.

The controller 40 instructs the tracking servo circuit 37 to control the tracking servo based on the tracking error signal TE-1 at the time of reproducing.

At the time of reproducing, as described above, the servo control based on the reflected light of the second laser beam is not necessarily performed. However, for example when position information at the time of reproducing is detected based on information recorded by wobbling of a groove or position information recorded by a pit string is detected, the servo control of the second laser beam can be made on the race formed surface (the selective reflection film 3) at the time of reproducing.

### 6. Modified Example

The embodiment of the present invention is described above, but the present invention is not limited to the above-described specific examples.

For example, the description about the method of manufacturing an optical recording medium is given on the case where the intermediate layer 4 is formed by spin-coating using the UV curing resin, but so-called HPSA (sheet-shaped UV curing PSA: Pressure Sensitive Adhesive) can be also used as the intermediate layer 4. A light curing resin, a thermosetting resin or the like can be used as the intermediate layer 4.

The above description is given on the example that the UV curing resin is used as the resin material of the recording layer 5, but the resin material is not limited to the UV curing resin and a light curing resin may be used. Instead of the light curing resin, the thermosetting resin can be used.

As the forming material of the recording layer 5, a photopolymerization resin, a light transparent resin, a high-performance engineering plastic material or the like can be used.

The method of manufacturing an optical recording medium is not limited to those described in the embodiment.

One example is a method of manufacturing an optical recording medium in which a sheet-shaped recording layer 5 is formed in advance, and the sheet-shaped recording layer 5 is sandwiched between HPSA described above. Specifically, HPSA is placed on the selective reflection film 3, the sheet-shaped recording layer 5 is placed thereon, ultraviolet rays are emitted (adhered) thereto, HPSA is placed, the sheet-shaped recording layer 5 is placed thereon, ultraviolet rays are emitted (adhered) thereto and so on in a repeated manner. As a result, the negative type recording medium 1 is manufactured.

With such a manufacturing method, the sheet materials are laminated so that the negative type recording medium 1 can be manufactured, with the result that the manufacturing steps can be further simplified.

Further, the thicknesses of the respective layers composing the negative type recording medium 1 are not limited to the described numerical values, and the thicknesses can be suitably changed according to the actual embodiment.

The refractive indexes n of the respective layers in the recording layer 5, the refractive index difference Δn, and the refractive index of the intermediate layer 4 are not limited to the described numerical values. They can be suitably changed according to the actual embodiment.

The above description is given on the case where the race is formed on the optical recording medium as the structure that enables the guide of the recording (and reproducing) position, but instead of such a race, a mark may be recorded on a phase-change film or the like. That is to say, error signals and position information of focus and tracking are obtained based on a mark string for guiding positions recorded in such a manner.

The above description is given on the case where the optical recording medium of the embodiment of the present invention is the disc-shaped recording medium, but the optical recording medium may have other shapes such as a rectangular shape.

The present application contains subject matter related to that disclosed in Japanese Priority Patent Application JP 2009-206756 filed in the Japan Patent Office on Sep. 8, 2009, the entire content of which is hereby incorporated by reference.

It should be understood by those skilled in the art that various modifications, combinations, sub-combinations and alternations may occur depending on design requirements and other factors insofar as they are within the scope of the appended claims or the equivalents thereof.

What is claimed is:

1. An optical recording medium, comprising:
recording layers including a diffraction grating having a predetermined grating pitch, the diffraction grating being obtained by alternately laminating first layers and second layers being transparent and having slightly different refractive indexes; and
intermediate layers being transparent and having a larger thickness than that of the recording layers, the recording layers and the intermediate layers being alternately laminated.

2. The optical recording medium according to claim 1,
wherein the intermediate layers have a refractive index set to the same value as that of any one of the first layers and the second layers.

3. The optical recording medium according to claim 1,
wherein the intermediate layer is made of a light curing resin.

4. The optical recording medium according to claim 1,
wherein the intermediate layer has the thickness of 10 μm or more.

5. A method of manufacturing an optical recording medium in which recording layers and intermediate layers are alternately laminated, the method comprising:
generating the recording layers including a diffraction grating, the diffraction grating being provided with a predetermined grating pitch by alternately laminating a first material and a second material that are transparent and have slightly different refractive indexes, into predetermined thicknesses at a several number of times; and
generating the intermediate layers that are transparent and have a thickness larger than that of the recording layers.

6. A recording method of recording a deletion mark on an optical recording medium according to recording information, comprising
emitting a laser beam according to the recording information with a focus position of the laser beam matching with a recording layer of the optical recording medium as a target for recording, and planarizing a refractive index distribution on the recording layer as the target for the recording, the optical recording medium being configured by alternately laminating the recording layers and intermediate layers, the recording layers including a diffraction grating provided with a predetermined grating pitch by alternately laminating first layers and second layers that are transparent and have refractive indexes being slightly different from each other, the intermediate layers being transparent and having a larger thickness than that of the recording layers.

7. A reproducing method for an optical recording medium, comprising:
emitting a laser beam to the optical recording medium where a deletion mark corresponding to recording information is formed on recording layers of the optical recording medium with the laser beam being focused on the recording layer as a target for reproduction, the optical recording medium being configured by alternately laminating the recording layers and intermediate layers, the recording layers including a diffraction grating provided with a predetermined grating pitch by alternately laminating first layers and second layers that are transparent and have refractive indexes being slightly different from each other, the intermediate layers being transparent and having a larger thickness than that of the recording layers;
detecting reflected light of the laser beam emitted at the emitting a laser beam; and
reproducing the information recorded on the recording layer as the target for reproduction based on a detected result of the reflected light at the detecting reflected light.
